(19) United States
(12) Patent Application Publication
(10) Pub. No.: US 2008/0120239 A1
(43) Pub. Date: May 22, 2008

(54) Method and System for Adapting Pre-Defined Rights of a Digital Content

(75) Inventors: Sandeep M. Adwankar, Buffalo Grove, IL (US); William A. Myers, Buffalo Grove, IL (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/562,214

(22) Filed: Nov. 21, 2006

(51) Int. Cl. G06Q 99/00

(52) U.S. Cl. 705/51

(57) ABSTRACT

A method and system for adapting one or more pre-defined rights of a digital content (106) is disclosed. The method includes detecting (304) transformation of the digital content. The transformation results in a transformed digital content. The method also includes evaluating (306) a new content utility value of the transformed digital content. Further, the method includes processing (308) the one or more pre-defined rights of the digital content based on the evaluation of the new content utility value.

The present invention generally relates to Digital Rights Management (DRM), and more particularly to adapting rights of a digital content.

### BACKGROUND OF THE INVENTION

Digital Rights Management (DRM) is a term used to describe a range of techniques that use information about rights associated with a digital content to control access of the digital content by an end-user. The rights associated with the digital content define restrictions on the digital content. Examples of these rights include forbidding copying of the digital content to a storage device, limiting the number of times the digital content can be accessed, specifying a total playback time for the digital content, the number of times the digital content can be re-distributed to another end-user, restricting the digital content to be played only on a certain type of machine. Examples of the digital content can be digital data, digital audio, digital video, digital text, digital multimedia, etc. The typical mode of distributing the digital content to the end-user can be intangible media such as the internet, electronic bulletin boards etc, and tangible devices such as compact disks (CDs), floppy disks etc.

Typically, the rights associated with the digital content are set by a content provider and distributed to the end-user. The content provider would generally distribute the digital content to the end-user in exchange for a subscription fee. Sometimes an end-user electronic device of the end-user may not be compatible with the features of the digital content. For example, an end-user electronic device such as a mobile phone may not support the digital multimedia content which has both audio and video format. Also, some mobile phone may not support Motion Picture Expert Group (MPEG) 2 video content at a certain bit rate and frame rate and hence the video content must be downgraded to the format that mobile phone supports. Another example of an end-user electronic device not being compatible with the features of a digital content is that of a Motion Picture Expert Group Audio Layer 3 (MP3) player which can only support a digital audio content in monophonic sound and not stereophonic sound. In the above examples the quality of the digital content is downgraded when the end-user access it. However in both examples, the rights of the digital content remain the same. As a result, subsequent to paying the subscription fee by the end-user, the end-user has to access the digital content with downgraded quality and with the initially set rights. This leads to an overall low content benefit to the end-user. However if the end-user could be compensated for the downgraded quality by say increasing the number of times the digital content can be re-distributed to other end-user, the end-user might be satisfied.

Therefore, a need exists for a method and system for adapting the rights of a digital content to an end-user electronic device of an end-user.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary environment, where various embodiments of the present invention can be practised;

FIG. 2 illustrates a block diagram of a Digital Rights Management (DRM) adapter for adapting one or more pre-defined rights of a digital content, in accordance with an embodiment of the present invention;

FIG. 3 is a flow diagram illustrating a method for adapting one or more pre-defined rights of a digital content, in accordance with an embodiment of the present invention; and

FIGS. 4 and 5 is a flow diagram illustrating a method for adapting one or more pre-defined rights of a digital content, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help to improve an understanding of embodiments of the present invention.

### DETAILED DESCRIPTION

Before describing in detail the particular method and system for adapting one or more pre-defined rights of a digital content, in accordance with various embodiments of the present invention, it should be observed that the present invention resides primarily in combinations of method steps related to adapting one or more pre-defined rights of a digital content. Accordingly, the apparatus components and method steps have been represented, where appropriate, by conventional symbols in the drawings, showing only those specific details that are pertinent for an understanding of the present invention, so as not to obscure the disclosure with details that will be readily apparent to those of ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

For one embodiment a method for adapting one or more pre-defined rights of a digital content is provided. The one or more pre-defined rights being parameters that modify the functionality of the digital content, the digital content having a pre-defined content utility value. The method includes detecting transformation of the digital content. The transformation results in a transformed digital content. The method further includes evaluating a new content utility value of the transformed digital content. Further, the method includes processing the one or more pre-defined rights of the digital content based on the evaluation of the new content utility value.

For another embodiment a Digital Rights Management (DRM) adapter for adapting one or more pre-defined rights of a digital content is provided. The one or more pre-defined rights being parameters that modify the functionality of the digital content, the digital content having a pre-defined content utility value. The system includes a processor, a utility calculator and a Rights Object (RO) adaptation engine. The processor is capable of detecting transformation of the digital content. The transformation results in a transformed digital content. The utility calculator is capable of calculating a new content utility value for the transformed digital content. Further the RO adaptation engine is capable of processing the one or more pre-defined rights of the digital content based on the new content utility value.

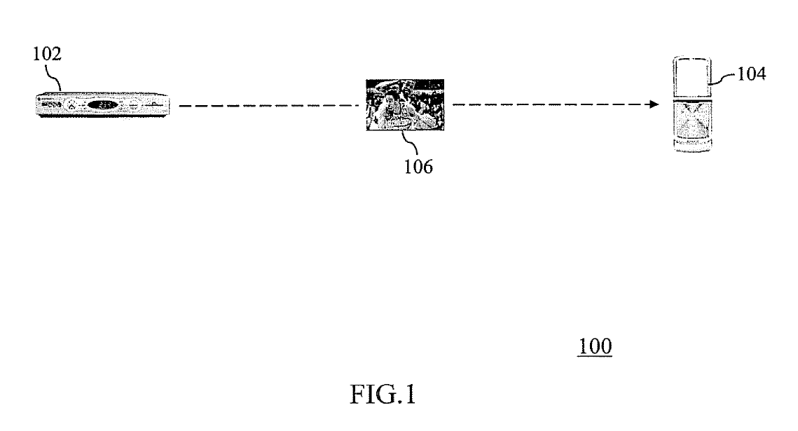

FIG. 1 illustrates an exemplary environment 100, where various embodiments of the present invention can be practised. The environment 100 includes a content provider device 102 and an end-user electronic device 104. The content provider device 102 is used by a content provider for distributing a digital content 106. The content provider is the owner of the digital content 106 and is capable of setting one or more rights for the digital content 106. Various content providers include broadcaster, an author, a publisher, TV stations, artists, etc. Though the content provider device 102 is depicted as a set-top box in the FIG. 1, it will be apparent to a person ordinarily skilled in the art that the content provider device 102 may be any content provider device other than the set-top box, for example, a server, a computer, etc. The end-user electronic device 104 used by an end-user can receive the digital content 106 distributed by the content provider device 102. For example, the end-user can receive the digital content 106 on paying a subscription fee for the digital content 106 to the content provider. Though the end-user electronic device 104 is depicted as a mobile phone in the FIG. 1, it will be apparent to a person ordinarily skilled in the art that the end-user electronic device 104 may be any end-user electronic device other than the mobile phone, for example, a personal computer, a laptop, a Personal Digital Assistant (PDA), etc. Examples of the digital content can be digital data, digital audio, digital video, digital text, digital multimedia, etc.

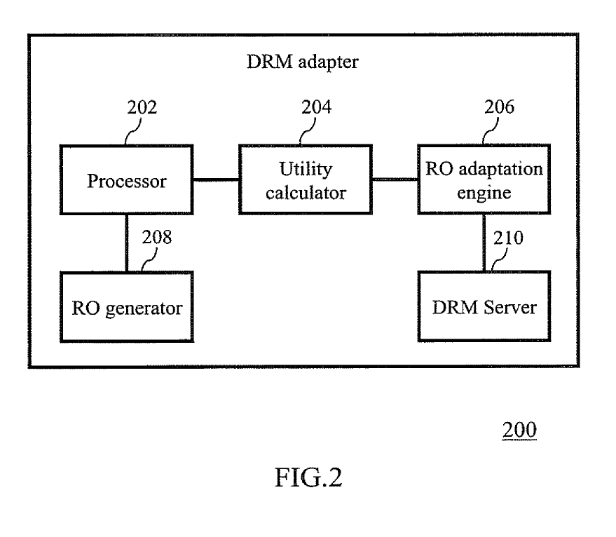

FIG. 2 illustrates a block diagram of a Digital Rights Management (DRM) adapter 200 for adapting one or more pre-defined rights of a digital content, in accordance with an embodiment of the present invention. The DRM adapter 200 in the FIG. 2 is described with respect to the environment 100 in FIG. 1. The DRM adapter 200 includes a processor 202, a utility calculator 204, a Rights Object (RO) adaptation engine 206, an RO generator 208 and a DRM server 210. The processor 202 detects transformation of the digital content 106 when the digital content 106 is transmitted from the content provider device 102 to the end-user electronic device 104. For example, the digital content 106 which is a digital multimedia can be in MPEG2 format and the end-user electronic device 104 which is a mobile phone executes digital multimedia in MPEG4 format. As a result, the processor 202 detects the transformation of the format of the digital content 106 from MPEG2 to MPEG4. This transformation enables the end-user electronic device 104 to execute the digital content 106.

The digital content 106 has a pre-defined content utility value associated with it. The pre-defined content utility value is defined by a pre-defined content utility functions, which are a sum of a quality value, a mobility value, a popularity value and a distribution value. The utility calculator 204 is capable of calculating a new content utility value for the transformed digital content 106. The RO adaptation engine 206 processes the one or more pre-defined rights of the digital content 106 based on the new content utility value. Further, the RO generator 208 is adapted to generate new rights for the digital content 106 that has not been included in the one or more pre-defined rights. The DRM adapter 200 also includes the DRM server 210 for one embodiment of the present invention. The DRM server 210 facilitates communication between the content provider device 102 and the end-user electronic device 104. For one embodiment, the DRM adapter 200 can be implemented in a server that connects the content provider device 102 and the end-user electronic device 104. For another embodiment, the DRM adapter 200 can be implemented in the end-user electronic device 104. Further, a part of the DRM adapter 200, for example, the RO adaptation engine 206, the RO generator 208 and the DRM server 210 can be placed with the content provider in case of a scenario where the end-user transmits a digital content to another end-user. This scenario is referred to as super distribution of the digital content.

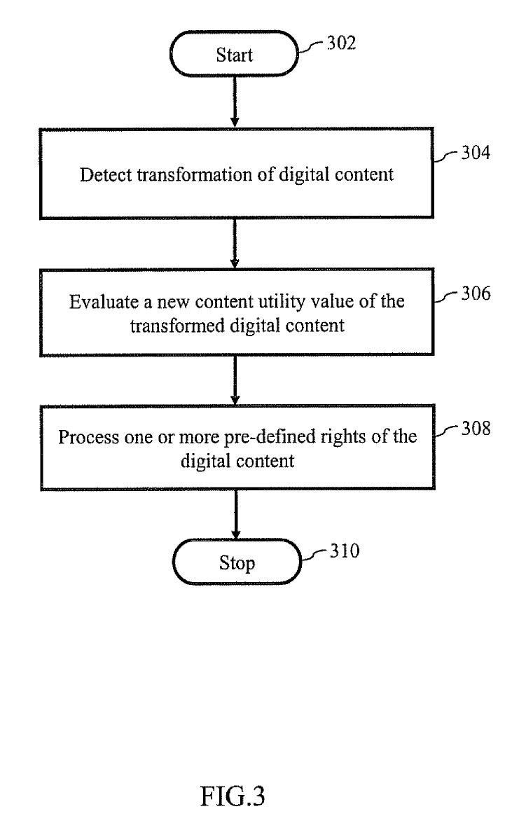

FIG. 3 is a flow diagram illustrating a method for adapting one or more pre-defined rights of a digital content, in accordance with an embodiment of the present invention. The flow diagram in FIG. 3 is described with respect to the environment 100 in FIG. 1. The process is initiated at step 302. At step 304, transformation of the digital content 106 is detected when the content provider device 102 transmits the digital content 106 to the end-user electronic device 104. The transformation results in a transformed digital content 106. At step 306, a new content utility value of the transformed digital content 106 is evaluated. Further, based on the evaluation of the new content utility value, one or more pre-defined rights of the digital content 106 is processed at step 308. Thereafter, the process terminates at step 310.

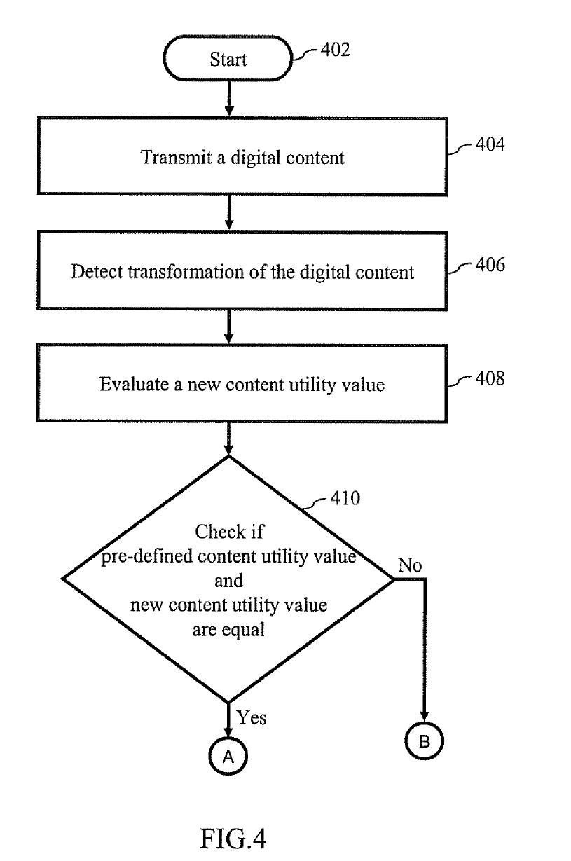

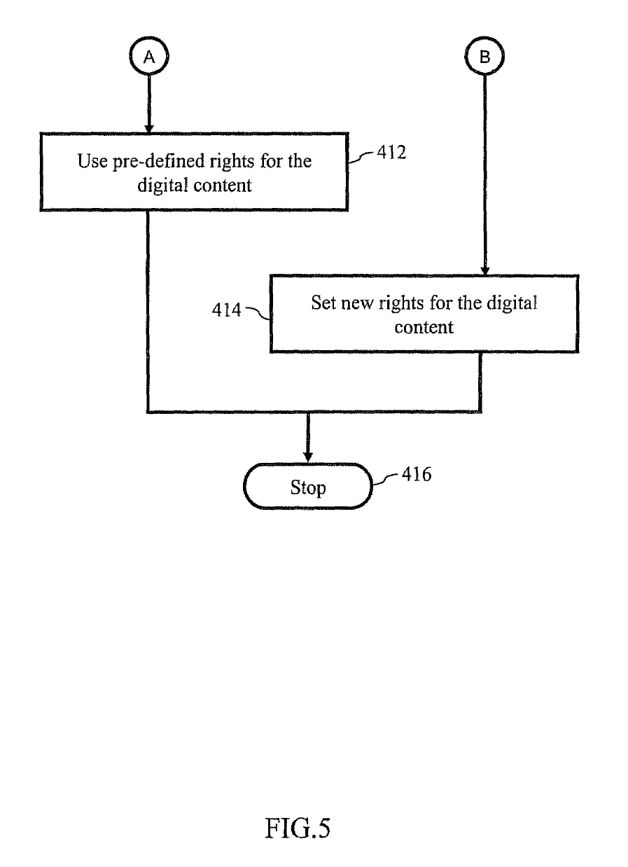

FIGS. 4 and 5 is a flow diagram illustrating a method for adapting one or more pre-defined rights of a digital content, in accordance with another embodiment of the present invention. The flow diagram in FIGS. 4 and 5 is described with respect to the environment 100 in FIG. 1 and the DRM adapter 200 in FIG. 2. The process is initiated at step 402. At step 404, the content provider transmits the digital content 106 using the content provider device 102 to the end-user electronic device 104. As mentioned earlier, the digital content 106 can be a digital multimedia transmitted by the set-top box depicted as the content provider device 102. In case of super distribution, the end-user electronic device 104 can receive the digital content 106 from another end-user electronic device. Super distribution is a method by which users can help increase the distribution and sale of a digital content by sharing the digital content with other users. An example of sharing the digital content is transmitting the digital content from an end-user electronic device of a user to an end-user electronic device of another user. The digital content 106 is transmitted along with one or more pre-defined rights. The one or more pre-defined rights are parameters capable of modifying the functionality of accessing the digital content 106. The one or more pre-defined rights are specified by the content provider before transmitting the digital content 106. Examples of the one or more pre-defined rights include rights to transfer the digital content 106, rights to playback or view the digital content 106 at a particular level of audio or visual resolution, rights to access the digital content 106, rights to copy the digital content 106. It will be apparent to a person ordinarily skilled in the art that the above cited one or more pre-defined rights are purely exemplary in nature and do not limit the scope of the invention. For instance, the content provider can specify the rights to transfer the digital content 106 as the capability of sending the digital content 106 to five other users from the end-user electronic device 104. The rights to playback or view the digital content 106 at a particular level of audio or visual resolution can be the capability of viewing the digital content 106 in monophonic sound and MPEG2 format. The rights to copy the digital content 106 can be the capability of copying the digital content 106 twice onto any storage devices. The rights to access the digital content 106 as playback duration of five days for the digital multimedia in the end-user electronic device 104.

The digital content 106 has a pre-defined content utility value. The pre-defined content utility value is defined by a pre-defined content utility functions, which are a sum of a quality utility function value, a mobility utility function value, a popularity utility function value and a distribution utility function value. Hereafter, the quality utility function value is referred to as a quality value, the mobility utility function value is referred to as a mobility value, the popularity utility function value is referred to as a popularity value, and the distribution utility function value is referred to as a distribution value.

The quality value is defined by a sum of utility factors such as content format utility factors, bit rate utility factors, resolution utility factors, frame rate utility factors, and media utility factors. The content utility factors provides weighted utility value based on digital content formats of the digital content 106, such as Moving Picture Experts Group (MPEG) 2, MPEG4, DivX, etc. The bit rate utility factors provides weighted utility value based on sampling rates of the digital content 106, such as 5 Mbit/s, 320 kbit/s, etc. The resolution utility factors provides weighted utility value based on the resolutions of the digital content 106, such as High Density (HD), Quarter Common Intermediate Format (QCIF), etc. The frame rate utility factors provides weighted utility value based on frame rates for the digital content 106, such as 60i, 30-frame progressive, etc. The media utility factors provides weighted utility value based on different types of output media of the digital content 106, such as audio and video, audio only, etc.

The mobility value is based on the number of times the digital content 106 can be moved to different end-user electronic devices. For example, in case of super distribution, if the digital content 106 has made five different transmissions on different end-user electronic devices to reach the end-user electronic device 104, then the mobility value of the digital content 106 can be five.

The popularity value is defined by a sum of a country location factor referred to as a country factor and a content popularity factor. The country factor is the value corresponding to a country where the digital content 106 is distributed because in some countries the value of the digital content 106 can be much higher than other countries. For example, the country factor of a digital video can be ten in United States of America (U.S.A) and the country factor of the digital video can be six in the United Kingdom (UK). Since the digital video has the higher country factor of ten in U.S.A as compared to the country factor of six in the UK, the digital video can have a higher popularity value in U.S.A than the UK. The content popularity factor is the value corresponding to the digital content 106 as identified by the popularity rating of the digital content 106 provided by rating organizations. For example, a digital video of a new movie can be given the popularity rating of ten compared to a digital video of an old movie that has the popularity rating of five. As a result, the new movie has a higher content popularity factor compared to the content popularity factor of the old movie.

The distribution value is defined as a sum of a content availability, a content publisher numbers, a content freshness, a content super distribution rank. The content availability is the value corresponding to the availability of the digital content 106. The content provider can have only a limited number of copies for the digital content 106, for example the content provider has only five copies of the digital content 106. Therefore the digital content 106 which has the number of copies as five can have a greater content availability compared to another digital content that has lesser number of copies compared to the digital content 106. The content publisher numbers is the value corresponding to the number of content providers available that transmits the digital content 106. Suppose there are four content providers that have the license to distribute a digital multimedia and seven content providers that have the license to distribute a digital audio, then the digital audio can have a higher content publisher number compared to the content publisher number of the digital multimedia. The content freshness is the value corresponding to the number of days elapsed since the digital content 106 has been introduced to the end-users. For example, if the number of days elapsed since a digital audio has been launched for distribution is one day and the number of days elapsed since a digital multimedia has been launched for distribution is five days, then the digital audio can have a higher content freshness value compared to the content freshness value of the digital multimedia. The content super distribution rank is the value corresponding to number of times the digital content 106 has been transmitted to different end-users by super distribution. For example, when a digital audio has made five different transmissions on five different mobile phones, then the digital audio will have a content super distribution rank that is higher than a digital multimedia which made three different transmissions on three different mobile phones.

At step 406, the processor 202 within the DRM adapter 200 detects the transformation of the digital content 106. The detection of the transformation is performed as a consequence of transmission of the digital content 106 by the content provider device 102 to the end-user electronic device 104. For instance, the digital content 106 which is the digital multimedia can be in MPEG2 format and the end-user electronic device 104 which is the mobile phone executes digital multimedia in MPEG4 format. As a result, the MPEG2 format of the digital content 106 is transformed to the MPEG4 format, which enables the end-user electronic device 104 to execute the digital content 106. The transformation results in a transformed digital content 106.

At step 408, after detecting the transformation of the digital content 106, the utility calculator 204 within the DRM adapter 200 evaluates a new content utility value of the transformed digital content 106. The evaluation step includes calculating the quality value, the popularity value, the distribution value and the mobility value associated with the transformed digital content 106. The new content utility value of the digital content 106 is calculated to check whether the one or more pre-defined rights set by the content provider need to be modified for the digital content 106 to adapt to the end-user electronic device 104. At step 410, the RO adaptation engine 206 checks if the pre-defined content utility value and the new content utility value are equal. In case of super distribution, the new content utility value calculated by utility calculator 204 can be transmitted to the content provider and received by the DRM server 210. Subsequently, the part of the DRM adapter 200 (RO adaptation engine 206) that lies with the content provider can check if the pre-defined content utility value and the new content utility value are equal.

If the pre-defined content utility value and the new content utility value are equal, then at step 412, the DRM adapter 200 assigns the one or more pre-defined rights of the digital content 106 specified by content provider as rights of the digital content 106 in the end-user electronic device 104. In other words, the one or more pre-defined rights are preserved. In case of super distribution, the part of the DRM adapter 200 (DRM server 210) located with the content provider can transmit the one or more pre-defined rights as rights for the digital content 106 to the end-user electronic device 104 when the pre-defined content utility value and the new content utility value are equal. For example, as specified initially by the content provider, the digital content 106 can have the playback duration of the digital multimedia as five days within the end-user electronic device 104, the rights to transfer the digital content 106 to other users as five from the end-user electronic device 104, the rights to playback or view the digital content 106 at a particular level of audio or visual resolution as the audio resolution of the digital content 106 in stereophonic sound and the rights to copy the digital content 106 can be the capability of copying the digital content 106.

If the pre-defined content utility value and the new content utility value are distinct, then at step 414, the RO adaptation engine 206 processes the one or more pre-defined rights by setting one or more new rights for the digital content 106. For an embodiment, the difference in the pre-defined content utility value and the new content utility value specify that the digital content 106 will be executed with downgraded quality in the end-user electronic device 104. For another embodiment, the difference in the pre-defined content utility value and the new content utility value specify that the digital content 106 will be executed with upgraded quality in the end-user electronic device 104. Therefore, the RO generator 208 within the DRM adapter 200 assists the RO adaptation engine 206 in setting the one or more new rights to the digital content 106. In case of super distribution, the part of the DRM adapter 200 (the RO generator 208) located with the content provider can set the one or more new rights for the digital content 106 and the part of the DRM adapter 200 (DRM server 210) can transmit the one or more new rights to the end-user electronic device 104 when the pre-defined content utility value and the new content utility value are distinct. The one or more new rights generated by the RO generator 208 are rights that were not included previously among the one or more pre-defined rights specified by the content provider.

For one embodiment, the one or more new rights results in an overall content benefit to the end-user of the end-user electronic device 104 when the digital content 106 is available with downgraded quality. For example, the DRM adapter 200 can set the rights to transfer the digital content 106 as ten instead of five as specified by the content provider, the rights to playback or view the digital content 106 at a particular level of audio or visual resolution as monophonic sound instead of stereophonic sound as specified by the content provider, the rights to copy the digital content 106 can be the capability of copying the digital content 106 five times onto any storage devices instead of twice as specified by the content provider, and the rights to access the digital content 106 as playback duration of ten days instead of the five day playback duration as specified by the content provider.

For another embodiment, the one or more new rights results in an overall content benefit to the end-user of the end-user electronic device 104 when the digital content 106 is available with upgraded quality. For example, the new content utility value can specify that a digital multimedia can be played in HD resolution on the end-user electronic device 104 such as a HD monitor and the pre-defined content utility value specify that the digital multimedia can be played in Standard Definition (SD) resolution. Consequently, the RO generator 208 can then set the rights to play the digital multimedia in HD resolution instead of SD resolution in the end-user electronic device 104 and can charge the user of the end-user electronic device 104 an additional subscription fee to the content provider.

For an embodiment, each of the one or more pre-defined rights for the digital content 106 can be modified to adapt to the end-user electronic device 104. For another embodiment, only one of the one or more pre-defined rights of the digital content 106 can be modified to adapt to the end-user electronic device 104. For yet another embodiment, the RO generator 208 can create a set of new rights previously not included by the content provider in the one or more pre-defined rights of the digital content 106. For example, if the one or more pre-defined rights for the digital content 106 includes the rights to transfer the digital content 106 as the capability of sending the digital content 106 to five other users from the end-user electronic device 104 and the rights to access the digital content 106 as playback duration of five days for the digital multimedia in the end-user electronic device 104 only, then the RO generator 208 can set new rights to the one or more pre-defined such as capability to play the digital content in stereophonic sound, capability to store unlimited copies of the digital content 106 onto any storage devices, etc. Thereafter the process terminates at step 416.

The embodiments of a method for adapting one or more pre-defined rights of a digital content offer numerous advantages. The modification of the one or more pre-defined rights of the digital content can offer the end-user better usage functionality for the subscription fee paid. Further, the components of the DRM adapter functions individually and does not utilize support from components of the end-user electronic device, the content provider device, the server that facilitates communication between the end-user electronic device and the content provider device. Therefore the DRM adapter does not cause any significant interference with the normal working of the end-user electronic device, the content provider device or the server.

It will be appreciated that the method and system for adapting one or more pre-defined rights of a content described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method to enable users to view a broadcasted media stream differently. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one of ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one of ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for adapting one or more pre-defined rights of a digital content, the one or more pre-defined rights being parameters that modify the functionality of the digital content, the digital content having a pre-defined content utility value, the method comprising:
detecting transformation of the digital content, wherein the transformation results in a transformed digital content;
evaluating a new content utility value of the transformed digital content; and
processing the one or more pre-defined rights of the digital content based on the new content utility value.

2. The method as recited in claim 1, wherein the transformation is performed as a consequence of transmission of the digital content to an end-user electronic device.

3. The method as recited in claim 1, wherein the one or more pre-defined rights for the digital content are specified by a content provider.

4. The method as recited in claim 1, wherein evaluating step comprises calculating a quality value associated with the transformed digital content.

5. The method as recited in claim 1, wherein evaluating step comprises calculating a popularity value associated with the transformed digital content.

6. The method as recited in claim 1, wherein evaluating step comprises calculating a distribution value associated with the transformed digital content.

7. The method as recited in claim 1, wherein evaluating step comprises calculating a mobility value associated with the transformed digital content.

8. The method as recited in claim 1, wherein the one or more pre-defined rights include rights to transfer the digital content.

9. The method as recited in claim 1, wherein the one or more pre-defined rights include rights to playback or view the digital content at a particular level of audio or visual resolution.

10. The method as recited in claim 1, wherein the one or more pre-defined rights include rights to access the digital content.

11. The method as recited in claim 1, wherein the one or more pre-defined rights include the rights to copy the digital content.

12. The method as recited in claim 1, wherein processing the one or more pre-defined rights comprises setting one or more new rights previously not included among the one or more pre-defined rights for the digital content.

13. A Digital Rights Management (DRM) adapter for adapting one or more pre-defined rights of a digital content, the one or more pre-defined rights being parameters that modify the functionality of the digital content, the digital content having a pre-defined content utility value, the DRM adapter comprising:
a processor capable of detecting transformation of the digital content, the transformation results in a transformed digital content;
a utility calculator capable of calculating a new content utility value for the transformed digital content; and
a Rights Object (RO) adaptation engine, the RO adaptation engine capable of processing the one or more pre-defined rights of the digital content based on the new content utility value.

14. The DRM adapter as recited in claim 13, wherein an RO generator is adapted to generate new rights for the digital content previously not included among the one or more pre-defined rights for the digital content.

15. The DRM adapter as recited in claim 13, wherein the one or more pre-defined rights include rights to transfer the digital content.

16. The DRM adapter as recited in claim 13, wherein the one or more pre-defined rights include rights to playback or view the digital content at a particular level of audio or visual resolution.

17. The DRM adapter as recited in claim 13, wherein the one or more pre-defined rights include rights to access the digital content.

18. The DRM adapter as recited in claim 13, wherein the one or more pre-defined rights include rights to copy the digital content.

19. The DRM adapter as recited in claim 13, wherein the DRM adapter comprises a DRM server facilitating communication between an end-user electronic device and a content provider.

20. The DRM adapter as recited in claim 19, wherein the end-user electronic device comprises the DRM adapter.

21. The DRM adapter as recited in claim 19, wherein the DRM adapter is implemented in a server connecting the content provider and the end-user electronic device.
